(19) United States
(12) Patent Application Publication
(10) Pub. No.: US 2010/0050063 A1
(43) Pub. Date: Feb. 25, 2010

(54) SYSTEM AND METHOD FOR CUSTOMIZABLE RESTRICTION MODE FOR DOCUMENT PROCESSING DEVICES

(76) Inventors: Manmohan GARG, Cerritos, CA (US); Rashmi Davangere Sripad, Lake Forest, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/194,898

(22) Filed: Aug. 20, 2008

(51) Int. Cl. G06F 17/00

(52) U.S. Cl. 715/200

(57) ABSTRACT

The subject application is directed to a system and method for customizable restriction mode for document processing devices. At least one document for processing is received, as well as document processing instructions for performing a selected document processing operation on a received document. A state of each of a plurality of functions associated with completion of the selected document processing operation is calculated, and each of a plurality of sub-functions corresponding to the plurality of functions is enabled. Timing data is generated for timing operation of each of a plurality of sub-functions in accordance with pre-selected timing characteristics. Control instructions are received, and operation of each of the plurality of sub-functions is controlled in a pre-selected order while enabled in accordance with timing data, state data, and the control instructions.

### BACKGROUND OF THE INVENTION

The subject application is directed generally to document processing operations. It is particularly applicable to the control of many sub-systems or sub-processes required for complex operation of modern office machines so as to allow for flexible administrative control and operation.

Modern document processing devices include printers, copiers, scanners, and facsimile devices. More recently, two or more of these functions have been included in a single device, which is referred to as a multifunctional peripheral (MFP) or multifunction device (MFD).

Document processing devices employ extremely sophisticated components that require precise control and timing. Such devices frequently rely on processors, operating on specialized software, to oversee and control these various components. In a typical device, each of a plurality of service agent processes is running, which service agents are directed to control of various device operations. Each service agent is always running as an active process, looking for requests for services to be performed.

### SUMMARY OF THE INVENTION

In accordance with one embodiment of the subject application, there is provided a system and method for customizable restriction mode for document processing devices. At least one document for processing is received, as well as document processing instructions for performing a selected document processing operation on a received document. A state of each of a plurality of functions associated with completion of the selected document processing operation is calculated, and each of a plurality of sub-functions corresponding to the plurality of functions is enabled. Timing data is generated for timing operation of each of a plurality of sub-functions in accordance with pre-selected timing characteristics. Control instructions are received, and operation of each of the plurality of sub-functions is controlled in a pre-selected order, while enabled in accordance with timing data, state data, and the control instructions.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a customizable restriction mode system for document processing devices according to one embodiment of the subject application;

FIG. 2 is a block diagram illustrating device hardware for use in the customizable restriction mode system for document processing devices according to one embodiment of the subject application;

FIG. 3 is a functional diagram illustrating the device for use in the customizable restriction mode system for document processing devices according to one embodiment of the subject application;

FIG. 4 is a block diagram illustrating controller hardware for use in the customizable restriction mode system for document processing devices according to one embodiment of the subject application;

FIG. 5 is a functional diagram illustrating the controller for use in the customizable restriction mode system for document processing devices according to one embodiment of the subject application;

FIG. 6 is a block diagram illustrating the customizable restriction mode system for document processing devices according to one embodiment of the subject application;

FIG. 7 is a functional diagram illustrating the customizable restriction mode system for document processing devices according to one embodiment of the subject application;

FIG. 8 is a flowchart illustrating a customizable restriction mode method for document processing devices according to one embodiment of the subject application; and

FIG. 9 is a flowchart illustrating a customizable restriction mode method for document processing devices according to one embodiment of the subject application.

### DETAILED DESCRIPTION OF THE PREFERRED EMBODIMENT

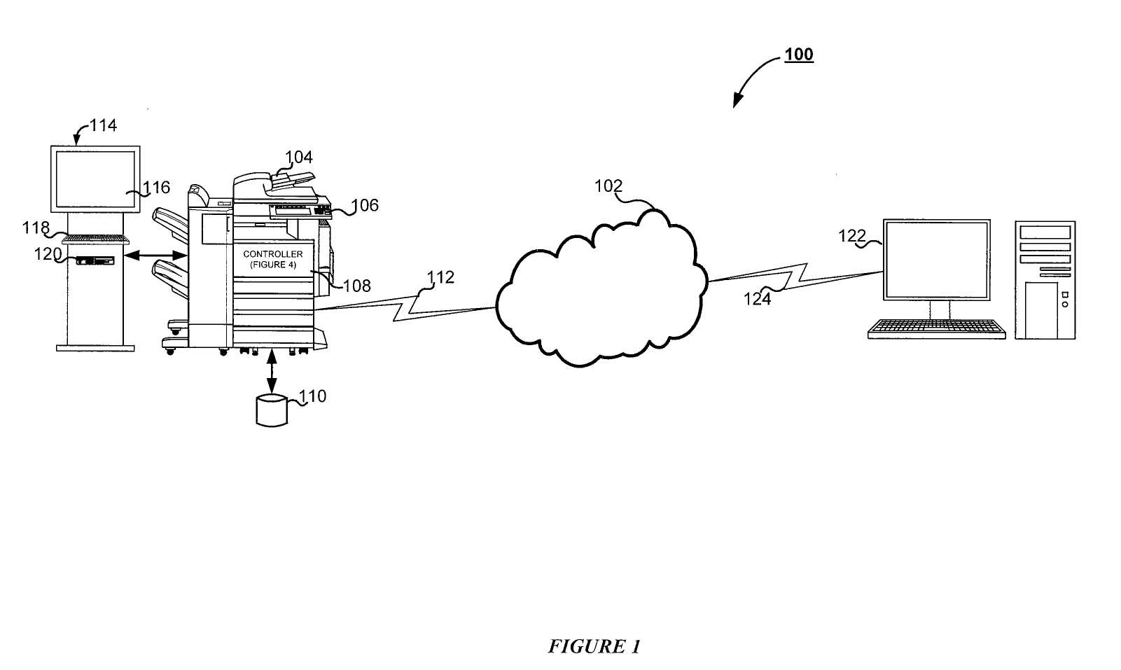

The subject application is directed to a system and method for document processing operations. In particular, the subject application is directed to a system and method for controlling sub-systems or sub-processes required for complex operation of modern office machines so as to allow for flexible administrative control and operation. More particularly, the subject application allows an administrative user to customize restriction modes for document processing devices. It will become apparent to those skilled in the art that the system and method described herein are suitably adapted to a plurality of varying electronic fields employing restrictive operation modes including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a customizable restriction mode system 100 for document processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

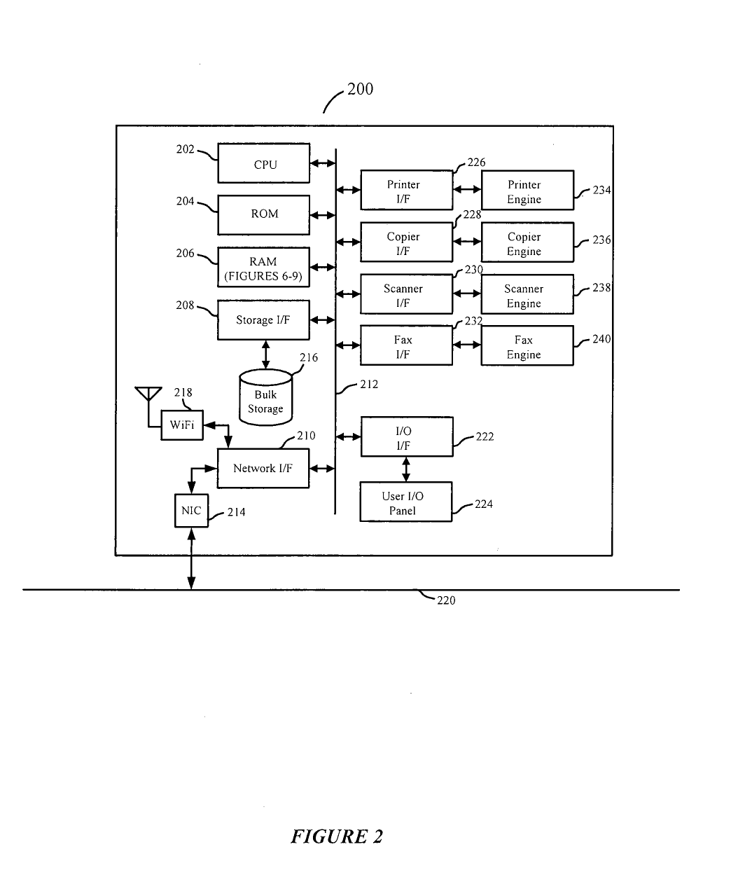

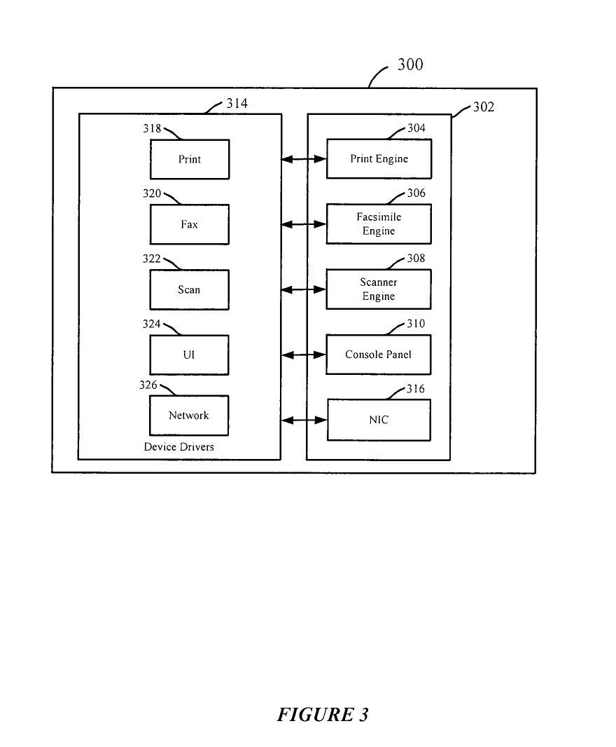

According to one embodiment of the subject application, the document processing device 104 is suitably equipped to receive a plurality of portable storage media including, without limitation, Firewire drive, USB drive, SD, MMC, XD, compact flash, memory stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, to receive input from the associated user, and to communicate the same to a backend component such as the controller 108, as explained in greater detail below. Preferably, the document processing device 104 is communicatively coupled to the computer network 102 via the communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

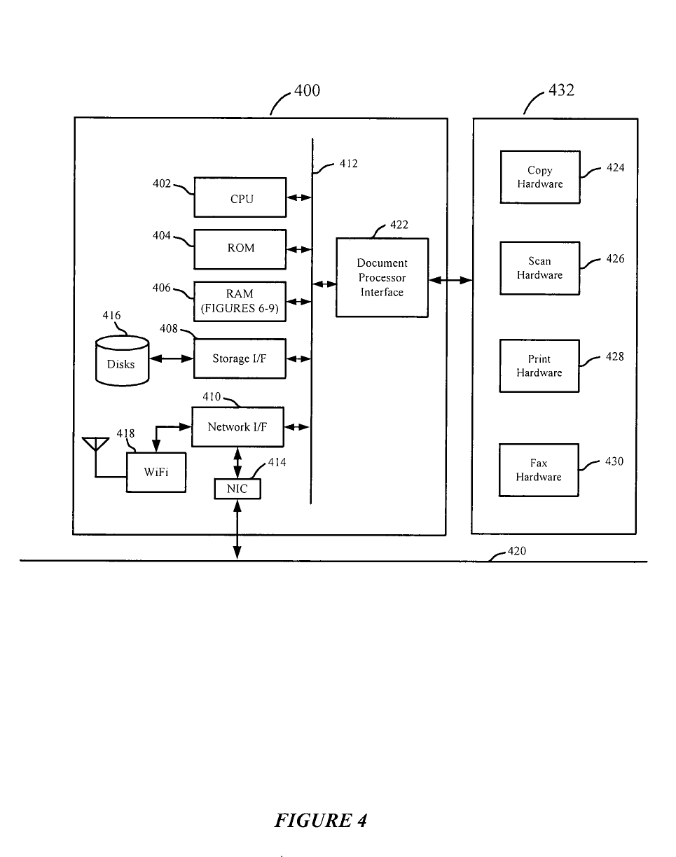

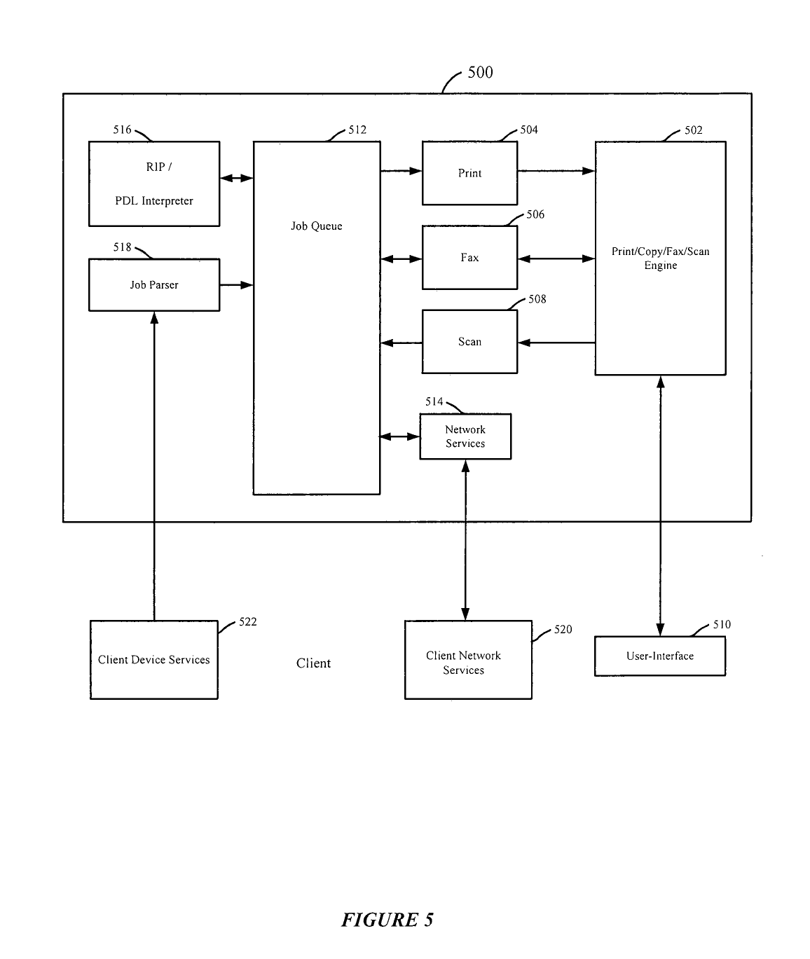

In accordance with one embodiment of the subject application, the document processing device 104 incorporates a backend component, designated as the controller 108, which is suitably adapted to facilitate the operations of the document processing device 104, as will be understood by those skilled in the art. Preferably, the controller 108 is embodied as hardware, software, or any suitable combination thereof configured to control the operations of the associated document processing device 104, to facilitate the display of images via the user interface 106, to direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the customizable restriction mode system and method for document processing devices. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store data records, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, internal hard disk drives or the like. In accordance with one embodiment of the subject application, the data storage device 110 is capable of storing document processing instructions, selectable document processing functions, sub-functions associated with such selectable functions, service agents associated with the sub-functions, job control data, controller data, component execution data, and the like.

Illustrated in FIG. 1 is a kiosk 114 communicatively coupled to the document processing device 104 and, in effect, the computer network 102. It will be appreciated by those skilled in the art that the kiosk 114 is capable of being implemented as a separate component of the document processing device 104 or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116 and a user input device 118. As will be understood by those skilled in the art, the kiosk 114 is capable of implementing a combination user input device/display, such as a touch screen interface. According to one embodiment of the subject application, the kiosk 114 is suitably adapted to display prompts to an associated user, to receive document processing instructions from the associated user, to receive payment data, to receive selection data from the associated user, and the like. Preferably, the kiosk 114 includes a magnetic card reader, conventional bar code reader, or the like suitably adapted to receive and read payment data from a credit card, coupon, debit card, or the like.

The system 100 of FIG. 1 also includes a portable storage device reader 120, respectively coupled to the kiosk 114, which is suitably adapted to receive and access myriad different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Depicted in FIG. 1 is an administrative device 122 in data communication with the computer network 102 via a communications link 124. It will be appreciated by those skilled in the art that the administrative device 122 is shown in FIG. 1 as a computer workstation for illustration purposes only. As will be understood by those skilled in the art, the administrative device 122 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 124 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative device 122 is suitably adapted to receive status data, job data, user interface data, and/or image data; to monitor document processing jobs; to employ thin client interfaces; to generate display data; to generate output data; to communicate restriction data; or the like with respect to the document processing device 104 or any other similar device coupled to the computer network 102.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326, suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices so as to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface card 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

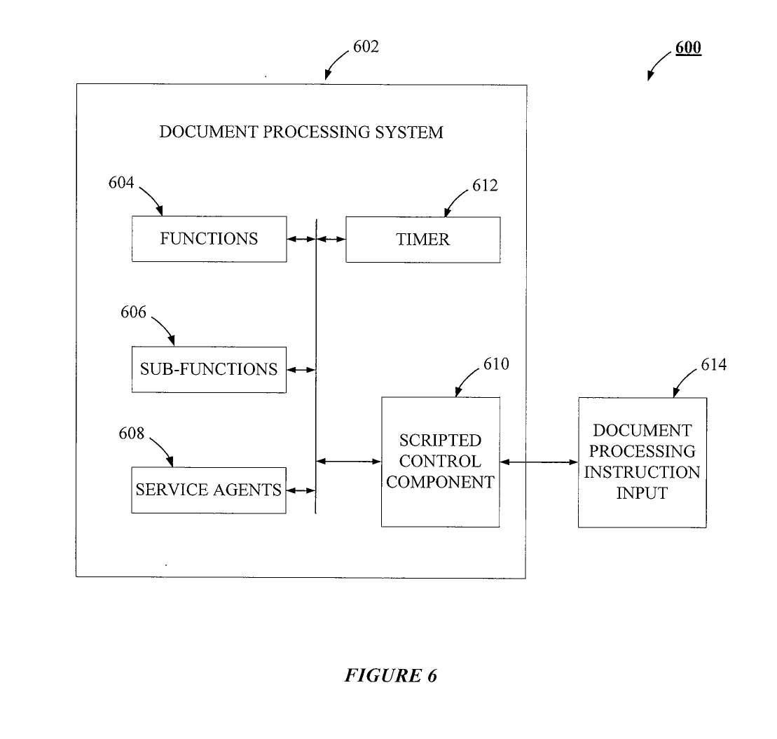

Turning now to FIG. 6, illustrated is a block diagram of a system 600 for customizable restriction modes for document processing devices in accordance with one embodiment of the subject application. The system 600 includes a document processing system 602 having a plurality of selectable document processing functions 604, each function 604 including a plurality of corresponding sub-functions 606. The document processing system 602 also includes a plurality of service agents 608, with each service agent 608 being associated with a sub-function 606. In addition, the document processing system 602 includes one or more timers 612 and a scripted control component 610. In accordance with one embodiment of the subject application, the scripted control component 610 includes enablement instructions for selectively enabling each service agent, timing instructions for timing operation of each of the sub-functions 606 in accordance with pre-selected timing characteristics and the timer 612, state calculation instructions for calculating a state of the services associated with the document processing system 602, and sub-function control instructions for controlling operation of the sub-functions 606 in accordance with the state of services, timing of sub-functions 606, and enabling of the service agents 608. A document processing instruction input 614 is communicatively coupled to the document processing system 602 so as to receive instructions corresponding to at least one desired document processing function 604 directed to a selected document. According to one embodiment of the subject application, the document processing function 604 is completed on the selected document by control of sub-functions 606 by the scripted control component 610 in accordance with the document processing instruction input 614.

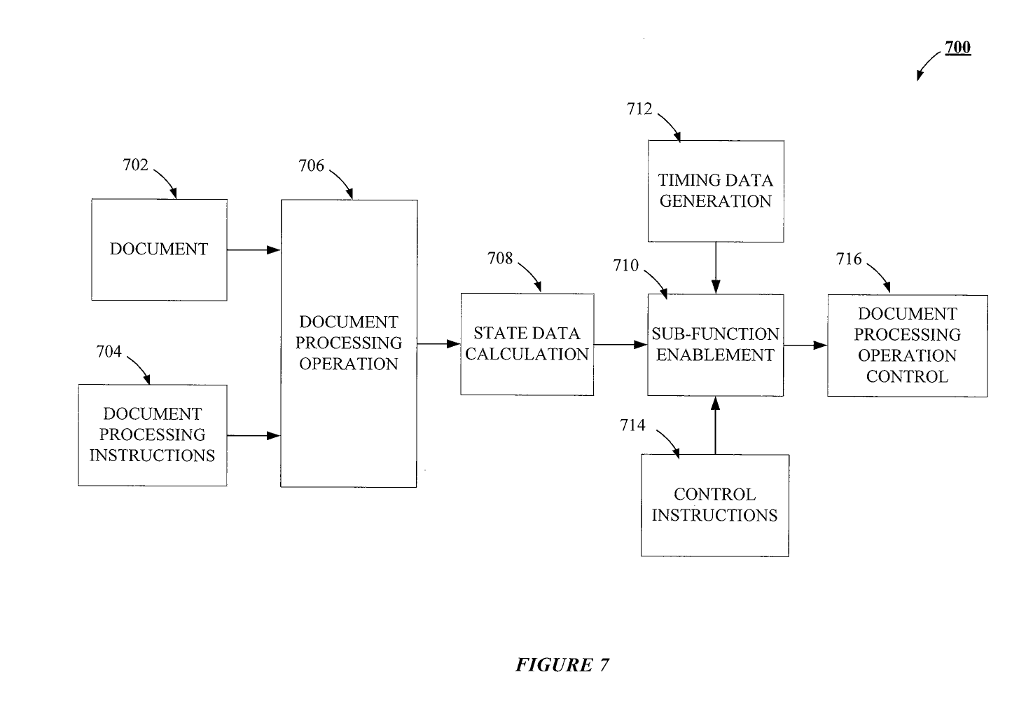

Referring now to FIG. 7, there is shown a functional diagram 700 illustrating the customizable restriction mode system for document processing devices in accordance with one embodiment of the subject application. A document 702 and document processing instructions 704 are received for a document processing operation 706. A state data calculation 708 is then performed to calculate the state of each of a plurality of functions associated with the completion of the document processing operation 706. Selective sub-function enablement 710 is then performed for each of a plurality of sub-functions corresponding to the functions associated with the completion of the document processing operation 706. Timing data generation 712 then occurs to generate timing data for operation of each of the sub-functions based upon pre-selected timing characteristics. Control instructions 714 are then received corresponding to control of the selectively enabled sub-functions. Document processing operation control 716 is thereafter performed on the enabled sub-functions in accordance with the timing data from the timing data generation 712, the state data from the state data calculation 708, and the control instructions 714.

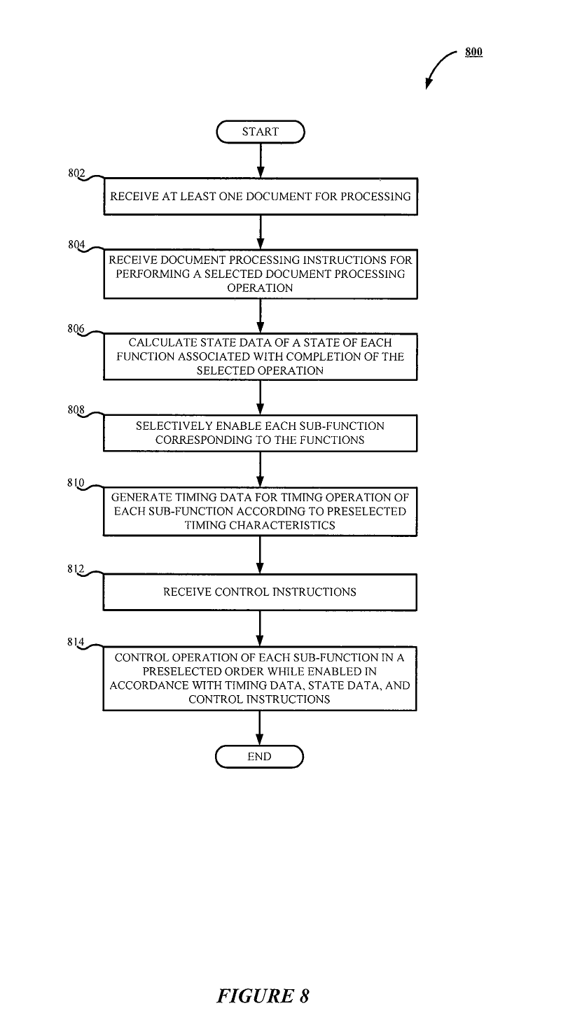

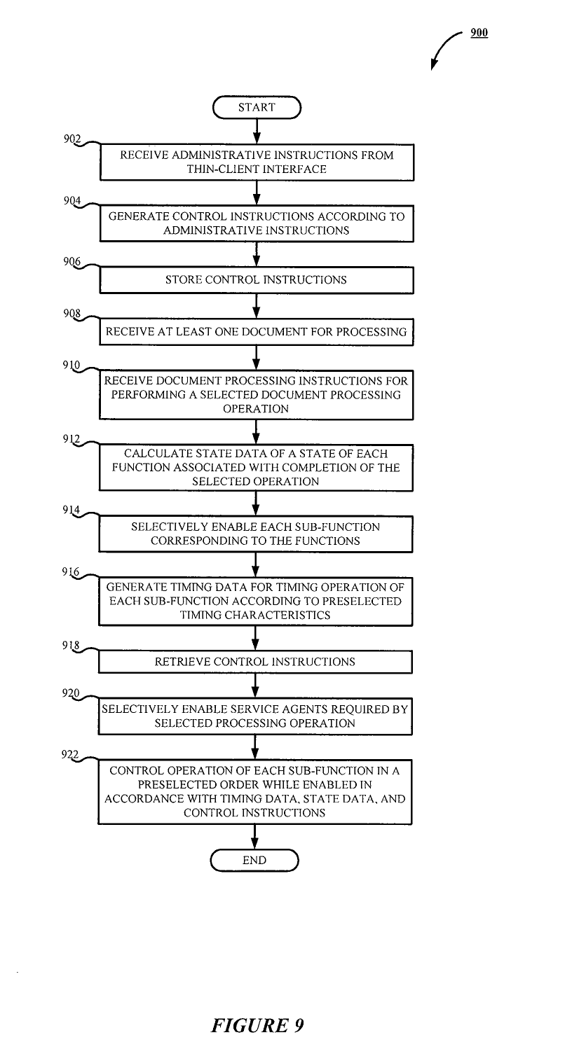

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a customizable restriction mode method for document processing devices in accordance with one embodiment of the subject application. Beginning at step 802, at least one document is received by the document processing device 104 for processing thereon. At step 804, the controller 108 or other suitable component associated with the document processing device 104 receives document processing instructions for performing a selected document processing operation on the received document.

The controller 108 or other suitable component associated with the document processing device 104 then calculates state data of a state of each of a plurality of functions associated with the completion of the selected document processing operation at step 806. At step 808, the controller 108 or other suitable component associated with the document processing device 104 selectively enables each of the sub-functions corresponding to the functions associated with the selected document processing operation. It will be appreciated by those skilled in the art that suitable sub-functions include, for example and without limitation, sleep, wake-up, low power, shut-down, and the like. Timing data is then generated by the controller 108 at step 810 for timing operation of each of the sub-functions based upon pre-selected timing characteristics. Control instructions are then received at step 812 corresponding to the control of the sub-functions corresponding to the functions associated with the selected document processing operation. At step 814, the controller 108 or other suitable component associated with the document processing device 104 controls the operation of each sub-function in a pre-selected order while enabled in accordance with the generated timing data, calculated state data, and the control instructions.

Referring now to FIG. 9, there is shown a flowchart 900 illustrating a customizable restriction mode method for document processing devices in accordance with one embodiment of the subject application. The methodology of FIG. 9 begins at step 902, whereupon administrative instructions are received by the controller 108 or other suitable component associated with the document processing device 104 from a thin client interface of the administrative device 122. According to one embodiment of the subject application, the administrative instructions are received in an extensible markup language document from an administrator or user associated with the administrative device 122. It will be appreciated by those skilled in the art that suitable thin client interfaces include, for example and without limitation, a dedicated software application, a web-browser, or the like. The controller 108 or other suitable component associated with the document processing device 104 then generates control instructions in accordance with the administrative instructions at step 904. The generated control instructions are then stored in the associated data storage device 110 at step 906.

The document processing device 104 then receives at least one document for processing at step 908. The controller 108 or other suitable component associated with the document processing device 104 then receives document processing instructions for performing a selected document processing operation at step 910. At step 912, the controller 108 or other suitable component associated with the document processing device 104 calculates the state data of a state of each of a plurality of document processing functions associated with the selected document processing operation. In accordance with one embodiment of the subject application, each function includes a corresponding plurality of associated sub-functions, as will be understood by those skilled in the art. Suitable sub-functions include, for example and without limitation, sleep, wake-up, low-power, or the like. At step 914, the controller 108 or other suitable component associated with the document processing device 104 selectively enables each sub-function corresponding to the document processing functions associated with the selected document processing operation.

The controller 108 then generates timing data for timing operation of each sub-function according to pre-selected timing characteristics at step 916. The controller 108 or other suitable component associated with the document processing device 104 then retrieves control instructions from the data storage 110 at step 918. In accordance with one embodiment of the subject application, such control instructions correspond to the selected document processing operation, as will be appreciated by those skilled in the art. At step 920, the controller 108 or other suitable component associated with the document processing device 104 selectively enables service agents required by the selected document processing operation. Operations of each sub-function are then controlled at step 922 in a pre-selected order while enabled in accordance with the calculated state data, generating timing data, and the retrieved control instructions.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application, to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A customizable restriction mode system for document processing devices, comprising:
a document processing system having a plurality of selectable document processing functions, each function including a plurality of corresponding sub-functions;
a plurality of service agents, each service agent being associated with a sub-function;
at least one timer;
a scripted control component including,
enablement instructions for selectively enabling each service agent,
timing instructions for timing operation of each of the plurality of sub-functions in accordance with pre-selected timing characteristics and the at least one timer,
state calculation instructions for calculating a state of services associated with the document processing system, and
sub-function control instructions for controlling operation of the sub-functions in accordance with the state of services, timing of sub-functions, and enabling of service agents; and
an input for document processing instructions corresponding to at least one desired document processing function directed to a selected document;
wherein the document processing function is completed on the selected document by control of sub-functions by the scripted control component.

2. The system of claim 1, wherein the sub-functions include at least one of sleep, wake-up, low power, and shut-down relative to document processing services associated therewith.

3. The system of claim 1, wherein the instructions are scripted so as to perform document processing functions associated in a power conservation mode of the document processing system by selectively enabling service agents required by the desired document processing operation.

4. The system of claim 3, wherein the scripted control component includes instructions comprised of extensible markup language instructions.

5. A customizable restriction mode method for document processing devices, comprising the steps of:
receiving at least one document for processing;
receiving document processing instructions for performing a selected document processing operation on a received document;
calculating state data of a state of each of a plurality of functions associated with completion of the selected document processing operation;
selectively enabling each of a plurality of sub-functions corresponding to the plurality of functions;
generating timing data for timing operation of each of the plurality of sub-functions in accordance with pre-selected timing characteristics;
receiving control instructions; and
controlling operation of each of the plurality of sub-functions in a pre-selected order while enabled in accordance with timing data, state data, and the control instructions.

6. The method of claim 5, wherein the sub-functions include at least one of sleep, wake-up, low power, and shut-down relative to document processing services associated therewith.

7. The method of claim 5, wherein the instructions are scripted so as to perform document processing functions associated in a power conservation mode by selectively enabling service agents required by the desired document processing operation.

8. The method of claim 5, further comprising the steps of:
receiving administrative instructions from an associated thin client interface; and
generating the control instructions in accordance with received administrative instructions.

9. The system of claim 7, wherein the administrative instructions are comprised of instructions in extensible markup language.

10. A customizable restriction mode system for document processing devices, comprising:
means adapted for receiving at least one document for processing;
means adapted for receiving document processing instructions for performing a selected document processing operation on a received document;
calculating means adapted for calculating state data representative of a state of each of a plurality of functions associated with completion of the selected document processing operation;
means adapted for selectively enabling each of a plurality of sub-functions corresponding to the plurality of functions;
means adapted for generating timing data for timing operation of each of the plurality of sub-functions in accordance with pre-selected timing characteristics;
means adapted for receiving control instructions; and
control means adapted for controlling operation of each of the plurality of sub-functions in a pre-selected order while enabled in accordance with timing data, state data, and the control instructions.

11. The system of claim 10, wherein each of the sub-functions is comprised of a passive service agent, which passive service agent receives operation input solely from the control means.

12. The system of claim 10, wherein the sub-functions include at least one of sleep, wake-up, low power, and shut-down relative to document processing services associated therewith.

13. The system of claim 10, wherein the instructions are scripted so as to perform document processing functions associated in a power conservation mode by selectively enabling service agents required by the desired document processing operation.

14. The system of claim 10, further comprising:
means adapted for receiving administrative instructions from an associated thin client interface; and
means adapted for generating the control instructions in accordance with received administrative instructions.

15. The system of claim 14, wherein the administrative instructions are comprised of instructions in extensible markup language.
